(19) United States
(12) Patent Application Publication
(10) Pub. No.: US 2023/0237503 A1
(43) Pub. Date: Jul. 27, 2023

(54) SYSTEM AND METHOD FOR DETERMINING COMMODITY CLASSIFICATIONS FOR PRODUCTS

(71) Applicant: Dell Products L.P., Round Rock, TX (US)

(72) Inventors: Irfan Gilani, Cedar Park, TX (US); Sreenivas Sathyanarayana Sharma, Round Rock, TX (US)

(73) Assignee: Dell Products L.P., Round Rock, TX (US)

(21) Appl. No.: 17/648,556

(22) Filed: Jan. 21, 2022

(51) Int. Cl. G06Q 30/00; G06Q 30/02; G06K 9/62

(52) U.S. Cl. CPC G06Q 30/018; G06Q 30/0283; G06K 9/6227

(57) ABSTRACT

In one aspect, an example methodology implementing the disclosed techniques includes, by an eco fees classification service, receiving information regarding a product to classify and generating a feature vector for the product, the feature vector representing a plurality of relevant features determined from the information regarding the product to classify. The method also includes, by the eco fee classification service, predicting, using an eco fees classification engine, a commodity classification for the product based on the feature vector, and recommending the commodity classification for the product for use in determining an eco fee to apply to a sale of the product. In some aspects, the method may also include computing the eco fee to apply to the sale of the product based on the recommended commodity classification.

### BACKGROUND

Organizations that manufacture and/or sell products that are potentially harmful to the environment, such as electronic products, pay environmental handling fees (or “eco fees”) to finance the recovery and recycling of such potentially harmful products at the end of their life cycle. Eco fee legislations in the various countries and regions in the world have different approaches to identifying or determining the products that are regulated and for which the eco fees should be levied under the eco fee legislation. The classes of products that the eco fee legislations target (i.e., the regulated products) and their corresponding eco fees are not based on any standard product classification/taxonomy. As a result, the organizations that manufacture/sell such products are challenged with having to understand the legislations, classify their products accordingly, and levy the applicable eco fees based on the product classifications.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one illustrative embodiment provided to illustrate the broader concepts, systems, and techniques described herein, a computer implemented method includes, by an eco fees classification service, receiving information regarding a product to classify and generating a feature vector for the product, the feature vector representing a plurality of relevant features determined from the information regarding the product to classify. The method also includes, by the eco fee classification service, predicting, using an eco fees classification engine, a commodity classification for the product based on the feature vector, and recommending the commodity classification for the product for use in determining an eco fee to apply to a sale of the product.

According to another illustrative embodiment provided to illustrate the broader concepts described herein, a system includes one or more non-transitory machine-readable mediums configured to store instructions and one or more processors configured to execute the instructions stored on the one or more non-transitory machine-readable mediums. Execution of the instructions causes the one or more processors to carry out a process including receiving information regarding a product to classify and generating a feature vector for the product, the feature vector representing a plurality of relevant features determined from the information regarding the product to classify. The process also includes predicting, using an eco fees classification engine, a commodity classification for the product based on the feature vector, and recommending the commodity classification for the product for use in determining an eco fee to apply to a sale of the product.

In some embodiments, the method/process further includes computing the eco fee to apply to the sale of the product based on the recommended commodity classification.

In some embodiments, the eco fees classification engine includes a machine learning (ML) classification model, and wherein the predicting is performed by the ML classification model.

In one aspect, the ML classification model is a dense neural network (DNN).

In some embodiments, the ML classification model is trained using a training dataset generated from a corpus of product data including historical eco fees compliance reports, product attribute data, product catalog data, and legislative reference data.

In one aspect, the historical eco fees compliance reports are indicative of adherence to one or more eco fee legislation by an organization.

In some embodiments, the plurality of relevant features includes a variable indicative of an attribute of the product.

In some embodiments, the plurality of relevant features includes a variable indicative of a selling context of the product.

According to another illustrative embodiment provided to illustrate the broader concepts described herein, a computer implemented method to generate a machine learning (ML) model to predict a commodity classification for a product includes determining, from a corpus of product data including historical eco fees compliance reports, product attribute data, product catalog data, and legislative reference data, a plurality of relevant features correlated with commodity classifications. The method also includes generating a modeling dataset using the identified plurality of relevant features, wherein the modeling dataset including a plurality of training samples and training the ML model using a portion of the plurality of training samples.

According to another illustrative embodiment provided to illustrate the broader concepts described herein, a system includes one or more non-transitory machine-readable mediums configured to store instructions and one or more processors configured to execute the instructions stored on the one or more non-transitory machine-readable mediums. Execution of the instructions causes the one or more processors to carry out a process including determining, from a corpus of product data including historical eco fees compliance reports, product attribute data, product catalog data, and legislative reference data, a plurality of relevant features correlated with commodity classifications. The process also includes generating a modeling dataset using the identified plurality of relevant features, wherein the modeling dataset includes a plurality of training samples and training a machine learning (ML) model using a portion of the plurality of training samples to predict a commodity classification for a product.

In some embodiments, the ML model is a classification model.

In one aspect, the classification model is a dense neural network (DNN).

In one aspect, the historical eco fees compliance reports are indicative of adherence to one or more eco fee legislation by an organization.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a block diagram of an illustrative system for intelligent product classification for eco fees, in accordance with an embodiment of the present disclosure.

FIG. 2 shows an illustrative workflow for a model building process, in accordance with an embodiment of the present disclosure.

FIG. 3 is a diagram showing an example topology that can be used to predict a commodity classification for eco fee purposes, in accordance with an embodiment of the present disclosure.

FIG. 4 is a flow diagram of an example process for determining a commodity classification for a product, in accordance with an embodiment of the present disclosure.

FIG. 5 is a block diagram illustrating selective components of an example computing device in which various aspects of the disclosure may be implemented, in accordance with an embodiment of the present disclosure.

### DETAILED DESCRIPTION

It is appreciated herein that it is increasingly challenging for organizations that manufacture/sell products to properly interpret and apply the enacted eco fee legislations. In many of these organizations, employees (e.g., data maintainers) are tasked with having to interpret the eco fee legislations and the legislative intent, understand all the sellable stock-keeping units (SKUs)/products offered by the particular organization, and classify (categorize) the SKUs/products based on their characteristics for eco fee purposes. For an organization that sells a large number of diverse products (e.g., configurable products, packaged products, third party products, etc.), these data maintainers may end up having to classify thousands and, in some cases, tens and hundreds of thousands of SKUs/products for eco fees purposes, which can be time consuming and costly to the organization. In addition, using data maintainers to classify the SKUs/products can result in inconsistent and inaccurate classifications due to the varying subjectivity and expertise of the data maintainers.

Certain embodiments of the concepts, techniques, and structures disclosed herein are directed to determining a commodity classification for a product based on product attributes and selling context (e.g., based on the product's attributes and selling context). The product may be being sold by an organization. In some embodiments, a learning algorithm (e.g., a classification algorithm) can be trained using machine learning techniques to predict commodity classifications for the organization's products. For example, in one embodiment, a classification algorithm may be trained using a modeling dataset generated from the organization's historical eco fees compliance reports, product attribute data, product catalog data, and legislative reference data. The historical eco fees compliance reports include documents that the organization has prepared and provided to the various eco fees regulatory authorities to show that the organization is adhering to the eco fee requirements and standards specified in the eco fee legislations. The trained machine learning (ML) classification model can then use used to predict a commodity classification for a product based on the attributes and selling context of the product.

As used herein, the term “commodity classifications” refer to the classes of products targeted by an eco fee legislation. In the eco fee legislation context, commodity classifications define the products that are being regulated (the “regulated products”) and to which the specified eco fees are applied. For a particular eco fee legislation, the commodity classifications are a way to determine which products are being regulated by the legislation. In the various eco fee legislations, the commodity classifications may be specified in terms of, for example, product type, product weight, product size, and/or other physical attributes of the commodity (i.e., product). These commodity classifications can vary between the different eco fee legislations. Also, there may be many different commodity classifications specified or defined in the various eco fee legislations and the specified classifications may not be “aligned” with the products that are manufactured and/or sold to consumers. Thus, a commodity classification specified or defined in an eco fee legislation may apply to one or more products that are sold to consumers.

As used herein, the term “selling context” refers, in addition to its ordinary meaning, to the manner in which a product is being sold. A selling context can be indicative of how the product is being sold. For example, taking an example of a keyboard, the keyboard may be being sold separately or as part of another product (e.g., as a component of a desktop computer). A particular eco fee legislation may specify an eco fee for a keyboard that is sold separately but not for a keyboard that is sold bundled with another product (e.g., no eco fee specified for a keyboard being sold as a component of a desktop computer). As another example, a product may be comprised of multiple components and/or subproducts or secondary products (e.g., a monitor and a power cable may comprise a product). A particular eco fee legislation may specify a first eco fee for a monitor and a second eco fee for a power cable. Thus, how a product is being sold is relevant to determining a commodity classification and the applicable eco fee. A selling context can also be indicative of to whom the product is being sold (“customer attributes”). In the keyboard example above, the keyboard may be being sold to a consumer of the keyboard (e.g., a person who intends to use the purchased keyboard) or to a reseller of the keyboard (e.g., a company or merchant that intends to sell the purchased keyboard instead of consuming the keyboard). A particular eco fee legislation may specify an eco fee for a keyboard that is sold to a consumer but not for a keyboard that is sold to a reseller (e.g., no eco fee specified for a keyboard being sold to a reseller). In the context of the particular eco fee legislation, a reseller of a product is “tax-exempt” is free from having to pay the specified eco fee (i.e., not obligated to pay the specified eco fee). Thus, to whom a product is being sold to is relevant to determining whether to apply or levy an applicable eco fee.

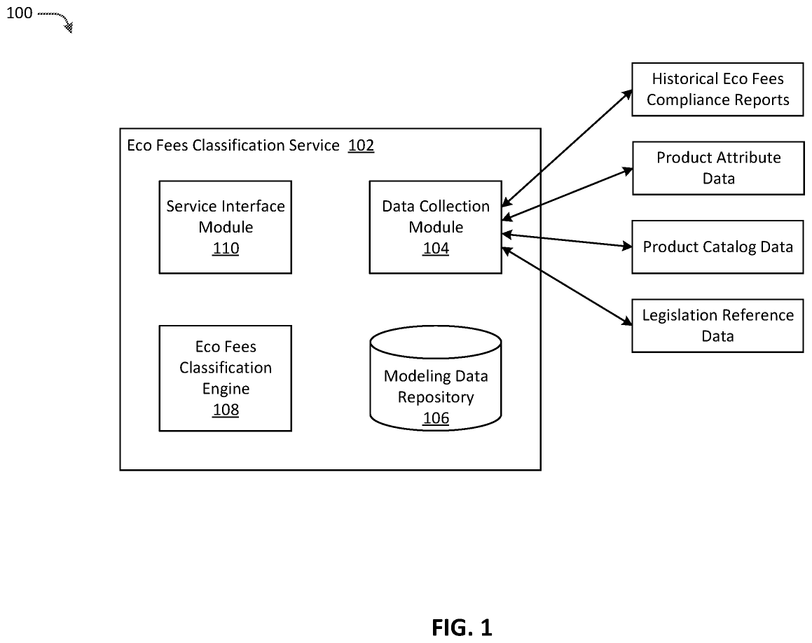

Referring now to FIG. 1, shown is an illustrative system 100 for intelligent commodity classification for eco fees, in accordance with an embodiment of the present disclosure. System 100 includes an eco fees classification service 102. In accordance with the various embodiments disclosed herein, eco fees classification service 102 can be implemented by an organization and used to predict (i.e., determine) commodity classifications for products that are being sold by the organization for eco fee purposes. For example, eco fees classification service 102 can be deployed in the organization's data center.

In some embodiments, eco fees classification service 102 can be provided as a service within a cloud computing environment, which may also be referred to as a cloud environment, cloud computing or cloud network. The cloud computing environment can provide the delivery of shared computing services (e.g., microservices) and/or resources to multiple users or tenants. For example, the shared resources and services can include, but are not limited to, networks, network bandwidth, servers, processing, memory, storage, applications, virtual machines, databases, software, hardware, analytics, and intelligence.

Eco fees classification service 102 can be implemented as computer instructions executable to perform the corresponding functions disclosed herein. Eco fees classification service 102 can be logically and/or physically organized into one or more components. The various components of eco fees classification service 102 can communicate or otherwise interact utilizing application program interfaces (APIs), such as, for example, a Representational State Transfer (RESTful) API, a Hypertext Transfer Protocol (HTTP) API, or another suitable API, including combinations thereof.

In the example of FIG. 1, eco fees classification service 102 includes a data collection module 104, a modeling data repository 106, an eco fees classification engine 108, and a service interface module 110. Eco fees classification service 102 can include various other components (e.g., software and/or hardware components) which, for the sake of clarity, are not shown in FIG. 1. It is also appreciated that eco fees classification service 102 may not include certain of the components depicted in FIG. 1. For example, in certain embodiments, eco fees classification service 102 may not include data collection module 104 and/or modeling data repository 106. In some such embodiments, some or all of the functionality provided by the excluded components may be provided by one or more of the included components of eco fees classification service 102 or provided by one or more components/systems that are external to eco fees classification service 102. Thus, it should be appreciated that numerous configurations of eco fees classification service 102 can be implemented and the present disclosure is not intended to be limited to any particular one.

Referring to eco fees classification service 102, data collection module 104 is operable to collect or retrieve the organization's historical eco fees compliance reports, product attribute data, product catalog data, and legislative reference data from one or more data sources. The data sources can include the organization's enterprise applications and data repositories. The enterprise applications can include, for example, manufacturing applications, parts applications, sales applications, and other enterprise resource planning (ERP), supply chain management (SCM) applications, and/or sales management (SM) applications. The data repositories can include, for example, DROPBOX, MICROSOFT ONEDRIVE, SHAREFILE, cloud-based storage service, or other suitable file system that hosts files, documents, and other materials. In some case, the data sources can include third party and/or vendor websites.

The historical eco fees compliance reports include documents that the organization has prepared and provided to the various eco fees regulatory authorities to show that the organization is adhering to the eco fee requirements and standards specified in the eco fee legislations. The historical eco fees compliance reports contain a list of products (e.g., SKUs) that have been sold by the organization and their corresponding commodity classifications. For example, for a compliance report provided to show compliance with a particular eco fee legislation, the report can list the products that have been sold by the organization in a country or region covered by the eco fee legislation. For each listed product, the compliance report can indicate a commodity classification specified in that eco fee legislation. Note that one or more products listed in a compliance report may indicate the same commodity classification. In some embodiments, the organization's historical eco fees compliance reports may be collected or retrieved from one or more of the organization's data repositories.

The product attribute data may include the technical specifications of the products that are being sold or have been sold by the organization. These products may be the organization's own products (e.g., products manufactured by the organization) as well as third party products (e.g., products that are manufactured by another organization and which are being resold by the organization). For example, for a particular product, the product attribute data may include information regarding the attributes of the product such as a size of the product, a weight of the product, amount of power consumed by the product, a list of components or included in the product and the attributes of the components, and other characteristics (e.g., engineering attributes). In some embodiments, the product attribute data may be collected or retrieved from one or more of the organization's data repositories and/or enterprise applications. The product attribute data for third party products may also be collected from product manuals/guides provided on the third party and/or vendor organization's websites.

The product catalog data may include the information provided in the organization's various product catalogs. The organization may have different product catalogs for the various different countries and regions in which the organization is conducting business (e.g., different product catalogs for the different regions in which the organization is selling products). For example, for a particular product catalog, the information may include a country or region corresponding to the product catalog (e.g., the country or region in which the product catalog applies), the product bundles, sales classifications, business segment, etc. For example, the organization's product catalog for Europe may indicate that a product (e.g., a mouse) is being sold separately, being sold bundled with a keyboard, and being sold bundled with a workstation. As another example, the organization's product catalog for Canada may indicate that the same product (e.g., the mouse) is only being sold bundled with a keyboard and being sold bundled with a workstation. Also, the product (e.g., mouse) in the product catalog for Europe may be classified the product catalog for Canada, the same product may be classified as an “optical mouse” (e.g., the same product may be may have different sales classifications in different sales catalogs). In any case, the organization's product catalogs include information that is indicative of the selling contexts of the various products being sold by the organization in the different countries and regions. That is, a particular product catalog provides the product information and other metadata from which the selling contexts of the products included in the product catalog can be determined. In some embodiments, the organization's product catalogs may be collected or retrieved from one or more of the organization's various data repositories, enterprise applications, and/or the organization's website (e.g., product sales pages on the website).

The legislative reference data may include commodity classifications that are defined in the various eco fee legislations. As explained above, the various eco fee legislations may specify or define different commodity classifications. The legislative reference data is indicative of the commodity classifications that are used in the various eco fee legislations enacted in the countries and regions in which the organization is conducting business. In some embodiments, the legislative reference data may be collected or retrieved from the various eco fees regulatory authority websites.

Data collection module 104 can utilize application programming interfaces (APIs) provided by the various data sources to collect information and materials therefrom. For example, data collection module 104 can use a REST-based API or other suitable API provided by an enterprise application to collect information therefrom (e.g., to collect the product attribute information). In the case of web-based applications, data collection module 104 can use a Web API provided by a web application to collect information therefrom. As another example, data collection module 104 can use a file system interface to retrieve the files containing historical eco fees compliance reports, product catalogs, engineering data sheets, etc., from a file system. As yet another example, data collection module 104 can use an API to collect documents containing historical eco fees compliance reports, product catalogs, engineering data sheets, etc., from a cloud-based storage service. A particular data source (e.g., an enterprise application and/or data source) can be hosted within a cloud computing environment (e.g., the cloud computing environment of eco fees classification service 102 or a different cloud computing environment) or within an on-premises data center (e.g., an on-premises data center of an organization that utilizes eco fees classification service 102).

In cases where an application or data repository does not provide an interface or API, other means, such as printing and/or imaging, may be utilized to collect information therefrom (e.g., generate an image of a product catalog page on a third party vendor website). Optical character recognition (OCR) technology can then be used to convert the image of the content to textual data.

In some embodiments, data collection module 104 can collect information from one or more of the various data sources on a continuous or periodic basis (e.g., according to a predetermined schedule specified by the organization). In some embodiments, data collection module 104 can store the information and materials collected from the various data sources within modeling data repository 106 that can correspond to, for example, a storage service within the computing environment of eco fees classification service 102.

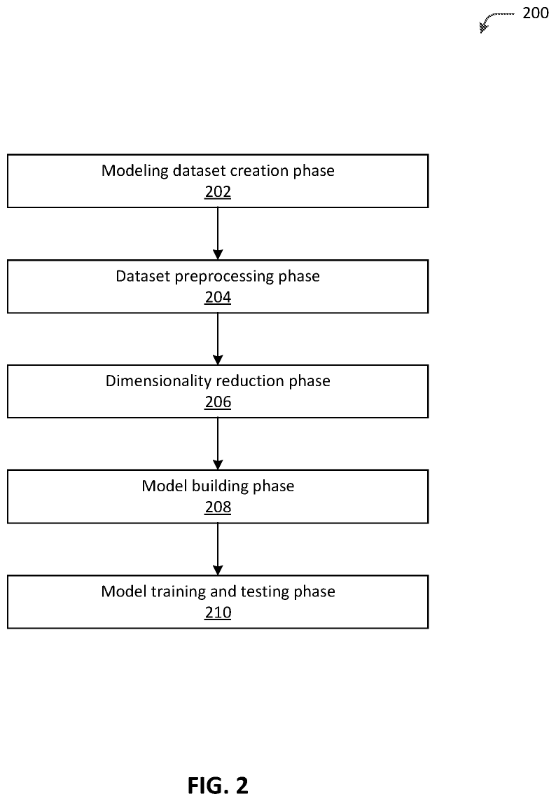

Data collection module 104 can use the information and other materials collected from the various data sources to generate or create a modeling dataset for training and testing a learning algorithm (e.g., a classification algorithm) using machine learning techniques to predict commodity classifications for the organization's products. For example, as will be further described below in conjunction with FIG. 2, the modeling dataset may be created as part of a model building process.

Eco fees classification engine 108 is operable to predict (i.e., determine) a commodity classification for a product. To this end, in some embodiments, eco fees classification engine 108 can include a machine learning (ML) classification model (e.g., a dense neural network (DNN)) that is trained and tested using machine learning techniques with a modeling dataset generated from the organization's historical eco fees compliance reports, product attribute data, product catalog data, and legislative reference data. In one embodiment, the DNN may be a ML classification model (e.g., a classification-based ML model). Once the ML model is created, eco fees classification engine 108 can, in response to input of information regarding a product (e.g., the product's attributes and selling context), predict a commodity classification for the product.

In some embodiments, the predicted commodity classification can be provided as an input to a pricing engine that is configured to determine (e.g., compute) an eco fee to apply to the product based on an applicable eco fee legislation. In some embodiments, the predicted commodity classification can be provided to the organization (e.g., a regulation compliance team within the organization) for validation of the commodity classification predicted for the product.

Service interface module 110 is operable to provide an interface to eco fees classification service 102. For example, in one embodiment, service interface module 110 may include an API that can be used, for example, by client applications to access and utilize eco fees classification service 102. For instance, a client application on a client device may send a request to determine a commodity classification for a product to eco fees classification service 102 via the API of service interface module 110. In some embodiments, service interface module 110 may include user interface (UI) controls that a user can click/tap/interact with to access and utilize eco fees classification service 102. For example, the UI controls may be presented on a UI of a client application on a client device via which a user can access and interact with eco fees classification service 102. For instance, in response to the user's input, the client application on the client device may send an appropriate request to eco fees classification service 102 (e.g., send a request to determine a commodity classification for a product). In any case, such a request may include information regarding the product that is to be classified.

Eco fees classification service 102 can, in response to receiving a request to determine a commodity classification for a product, utilize eco fees classification engine 108 to determine a commodity classification for the product. For example, in one embodiment, eco fees classification service 102 can send or otherwise provide the information regarding the product included or otherwise provided with the received request to eco fees classification engine 108 for prediction of a commodity classification for the product. Upon determining the commodity classification for the product, eco fees classification service 102 can include the commodity classification in a response to the received request (e.g., send or otherwise provide the commodity classification in a response to the request to determine a commodity classification for a product).

Referring now to FIG. 2 and with continued reference to FIG. 1, shown is an illustrative workflow 200 for a model building process, in accordance with an embodiment of the present disclosure. In particular, workflow 200 is an illustrative process for creating a ML classification model (e.g., a DNN) for eco fees classification engine 108. As shown, workflow 200 includes a modeling dataset creation phase 202, a dataset preprocessing phase 204, a dimensionality reduction phase 206, a model building phase 208, and a model training and testing phase 210.

In more detail, modeling dataset creation phase 202 can include collecting a corpus of product data from which to generate a modeling dataset. The corpus of product data can include the organization's historical eco fees compliance reports, product attribute data, product catalog data, and legislative reference data. For example, in one embodiment, data collection module 104 can collect the corpus of product data from the organization's various data sources, as previously described herein.

Dataset preprocessing phase 204 can include preprocessing the collected corpus of product data to be in a form that is suitable for training the ML classification model (e.g., a DNN). For example, in one embodiment, data collection module 104 can utilize natural language processing (NLP) algorithms and techniques to preprocess the collected text data (e.g., the organization's historical eco fees compliance reports, product data, product catalog data, legislative reference data, and other materials collected from the various data sources). For example, the data preprocessing may include tokenization (e.g., splitting a phrase, sentence, paragraph, or an entire text document into smaller units, such as individual words or terms), noise removal (e.g., removing whitespaces, characters, digits, and items of text which can interfere with the extraction of features from the data), stopwords removal, stemming, and/or lemmatization.

The data preprocessing may also include placing the data into a tabular format. In the table, the structured columns represent the features (also called “variables”) and each row represents an observation or instance (e.g., a particular product or SKU that is being sold or that was sold by the organization as reported in the historical eco fees compliance reports). Thus, each column in the table shows a different feature of the instance. The data preprocessing may also include placing the data (information) in the table into a format that is suitable for training a model. For example, since machine learning deals with numerical values, textual categorical values (i.e., free text) in the columns can be converted (i.e., encoded) into numerical values. According to one embodiment, the textual categorical values may be encoded using label encoding. According to alternative embodiments, the textual categorical values may be encoded using one-hot encoding.

The preliminary operations may also include null data handling (e.g., the handling of missing values in the table). According to one embodiment, null or missing values in a column (a feature) may be replaced by mean of the other values in that column. For example, mean imputation may be performed using a mean imputation technique such as that provided by Scikit-learn (Sklearn). According to alternative embodiments, observations in the table with null or missing values in a column may be replaced by a mode or median value of the values in that column or removed from the table.

The preliminary operations may also include feature selection and/or data engineering to determine or identify the relevant or important features from the noisy data. The relevant/important features are the features that are more correlated with the thing being predicted by the trained model (e.g., a commodity classification for a product/SKU). A variety of feature engineering techniques, such as exploratory data analysis (EDA) and/or bivariate data analysis with multivariate-variate plots and/or correlation heatmaps and diagrams, among others, may be used to determine the relevant features. For example, the relevant features may include the product attributes (e.g., information from the product technical specifications), the selling context (e.g., information from the product catalogs), and the legislative reference data (e.g., the different commodity classifications defined in the various eco fee legislations).

Each instance in the table may represent a training/testing sample (i.e., an instance of a training/testing sample) in the modeling dataset and each column may be a relevant feature of the training/testing sample. As previously described, each training sample may correspond to a product/SKU that is being sold or was sold by the organization. In a training/testing sample, the relevant features are the independent variables and the thing being predicted (a commodity classification) is the dependent variable. In some embodiments, the individual training/testing samples may be used to generate a feature vector, which is a multi-dimensional vector of elements or components that represent the features in a training/testing sample. In such embodiments, the generated feature vectors may be used for training or testing the ML classification model to predict commodity classifications for the organization's products.

Dimensionality reduction phase 206 can include reducing the number of features in the dataset. For example, since the modeling dataset is being generated from the corpus of product data that includes product attributes (e.g., the product attribute data), the number of features (or input variables) in the dataset may be very large. The large number of input features can result in poor performance for machine learning algorithms. For example, in one embodiment, data collection module 104 can utilize dimensionality reduction techniques, such as principal component analysis (PCA), to reduce the dimension of the modeling dataset (e.g., reduce the number of features in the dataset), hence improving the model's accuracy and performance. In one embodiment, data collection module 104 can utilize dimensionality reduction techniques to reduce the dimension of the dataset to three (3) features. In other embodiments, data collection module 104 can utilize dimensionality reduction techniques to reduce the dimension of the dataset to five (5), six (6), or any suitable number of features Data collection module 104 can then store the modeling dataset within modeling data repository 106.

Model building phase 208 can include creating a shell model (e.g., a DNN) and adding a number of individual layers to the shell model. For example, in one embodiment, eco fees classification engine 108 can create the shell model. For example, the shell model may be created using ML tools and libraries such as that provided by TensorFlow or another open-source project. In one illustrative implementation, the shell model may include an input layer, two (2) hidden layers, and an output layer. The input layer may be comprised of three (3) nodes (also known as “neurons”) to match the number of input variables (features) in the modeling dataset. The individual hidden layers may be comprised of an arbitrary number of nodes, which may depend on the number of nodes included in the input layer. For example, in one implementation, each hidden layer may be comprised of six (6) nodes. As a classification model, the output layer may be comprised of a single node. Each node in the hidden layers and the node in output layer may be associated with an activation function. For example, according to one embodiment, the activation function for the nodes in the hidden layers may be a rectified linear unit (ReLU) activation function. As the model is to function as a classification model, the activation function for the node in the output layer may be a sigmoid activation function.

Model training and testing phase 210 can include training and testing the shell model using the modeling dataset to create the ML classification model. For example, in one embodiment, eco fees classification engine 108 can train and test the shell model to create the ML classification model for predicting commodity classifications for the organization's products. For example, once the shell model is created, a loss function (e.g., binary cross entropy), an optimizer algorithm (e.g., Adam or a gradient-based optimization technique such as RMSprop), and validation metrics (e.g., “accuracy”) can be specified for training, validating, and testing the model. The model can then be trained by passing the portion of the modeling dataset (e.g., 90% of the modeling dataset) designated for training and specifying a number of epochs. An epoch (one pass of the entire training dataset) is completed once all the observations of the training data are passed through the model. The model can be validated once the model completes a specified number of epochs (e.g., 150 epochs). For example, the model can process the training dataset and a loss/error value can be computed and used to assess the performance of the model. The loss value indicates how well the model is trained. Note that a higher loss value means the model is not sufficiently trained. In this case, hyperparameter tuning may be performed. Hyperparameter tuning may include, for example, changing the loss function, changing the optimizer algorithm, and/or changing the model architecture (e.g., the neural network architecture) by adding more hidden layers. Additionally or alternatively, the number of epochs can be also increased to further train the model. In any case, once the loss is reduced to a very small number (ideally close to 0), the model is sufficiently trained for prediction. Prediction using the model can be achieved by passing the independent variables of the testing dataset (i.e., for comparing the training vs. testing) or the real values that need to be predicted to predict a commodity classification for a product (e.g., predict a commodity classification for a product being sold by the organization).

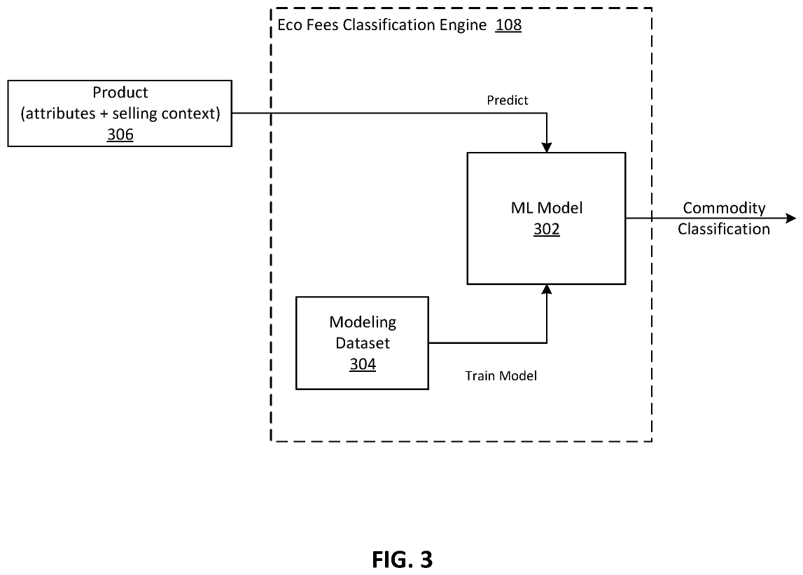

Referring now to FIG. 3, in which like elements of FIG. 1 are shown using like reference designators, shown is a diagram of an example topology that can be used to predict a commodity classification for eco fee purposes, in accordance with an embodiment of the present disclosure. As shown in FIG. 3, eco fees classification engine 108 includes a machine learning (ML) model 302. As described previously, according to one embodiment, ML model 302 can be a ML classification model (e.g., a DNN). ML model 302 can be trained and tested using machine learning techniques with a modeling dataset 304. Modeling dataset 304 can be retrieved from a data repository (e.g., modeling data repository 106 of FIG. 1). As described previously, modeling dataset 304 for ML model 302 may be generated from the collected corpus of product data (e.g., from the organization's historical eco fees compliance reports, product attribute data, product catalog data, and legislative reference data). Once ML model 302 is sufficiently trained, eco fees classification engine 108 can, in response to receiving information regarding a product, determine a commodity classification for the product. For example, as shown in FIG. 3, a feature vector that represents attributes of a product 306, such as some or all the variables that may influence the prediction of a commodity classification (e.g., variables indicative of one or more attributes of the product and a selling context of the product), may be determined and input, passed, or otherwise provided to the trained ML model 302. In some embodiments, the input feature vector (e.g., the feature vector representing product 306) may include the same features used in training the trained ML model 302. That is, the input feature vector may include the relevant features which were used in training ML model 302. The trained ML model 302 can then predict a commodity classification for product 306.

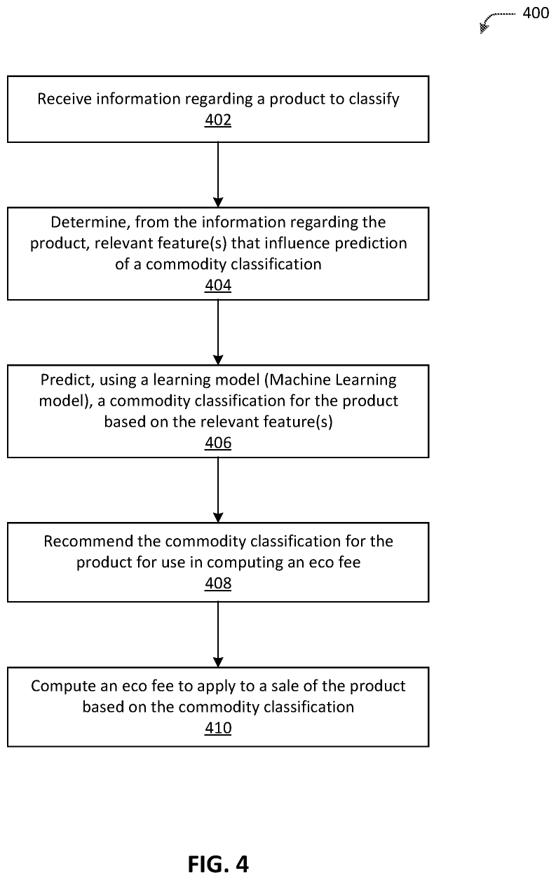

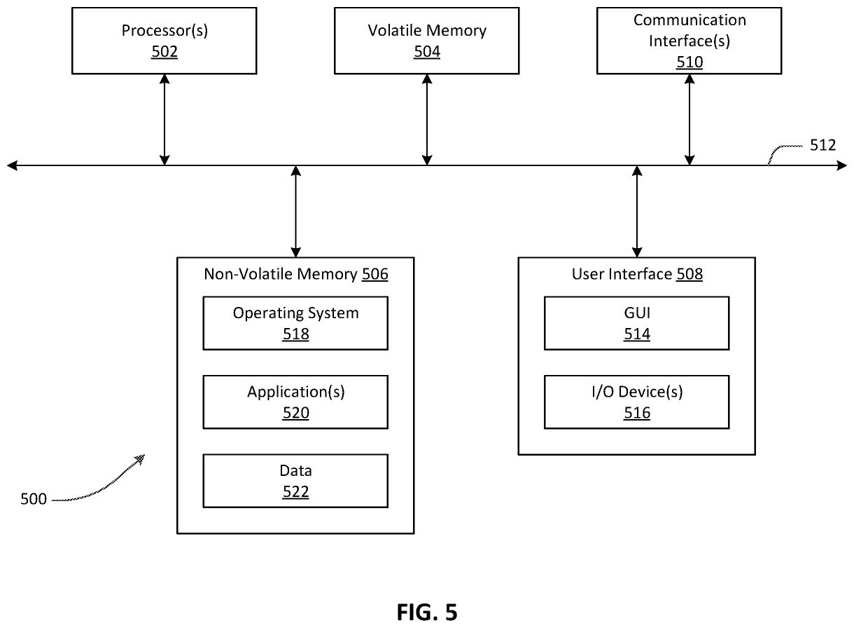

FIG. 4 is a flow diagram of an example process 400 for determining a commodity classification for a product, in accordance with an embodiment of the present disclosure. Process 400 may be implemented or performed by any suitable hardware, or combination of hardware and software, including without limitation the components of system 100 shown and described with respect to FIG. 1, the computing device shown and described with respect to FIG. 5, or a combination thereof. For example, in some embodiments, the operations, functions, or actions illustrated in process 400 may be performed, for example, in whole or in part by data collection module 104, eco fees classification engine 108, and service interface module 110, or any combination of these including other components of eco fees classification service 102 described with respect to FIG. 1.

With reference to process 400 of FIG. 4, and in an illustrative use case, at 402, eco fees classification service 102 can receive information regarding a product to classify. For example, the information regarding the product may be received via service interface module 110 along with or as part of a request to determine a commodity classification for the product.

In response to the information regarding a product being received, at 404, eco fees classification service 102 can determine relevant feature(s) from the received information regarding the product. The relevant feature(s) include variables (e.g., variables indicative of one or more attributes of the product and a selling context of the product) that influence a prediction of a commodity classification. For example, eco fees classification service 102 may perform the preliminary operations, such as null handling, feature selection, data engineering, and/or dimensionality reduction, as previously described herein, to determine the relevant features from the information regarding the product.

At 406, eco fees classification engine 108 can predict a commodity classification for the product based on the relevant features determined from the information regarding the product. For example, eco fees classification service 102 may generate a feature vector that represents the relevant features determined from the information regarding the product and provide the feature vector to eco fees classification engine 108. Eco fees classification engine 108 can, in response to receiving the feature vector, input the feature vector to a trained ML model (e.g., ML model 302 of FIG. 3), which outputs a prediction of a commodity classification for the product.

At 408, eco fees classification service 102 can recommend the commodity classification (e.g., the commodity classification for the product predicted by eco fees classification engine 108) for use in determining an eco fee to apply to a sale of the product. For example, in one embodiment, eco fees classification service 102 can send or otherwise provide the commodity classification to an organization that is requesting the classification of the product (e.g., a compliance team within the organization) for validation of the commodity classification.

At 410, an eco fee to apply to a sale of the product may be computed based on the recommended commodity classification. For example, in one embodiment, the recommended commodity classification may be provided as an input to a pricing engine that is configured to determine (e.g., compute) an eco fee to apply to the product based on an applicable eco fee legislation. In some such embodiments, the determination of the eco fee may be performed upon successfully validating the recommended commodity classification for the product.

FIG. 5 is a block diagram illustrating selective components of an example computing device 500 in which various aspects of the disclosure may be implemented, in accordance with an embodiment of the present disclosure. As shown, computing device 500 includes one or more processors 502, a volatile memory 504 (e.g., random access memory (RAM)), a non-volatile memory 506, a user interface (UI) 508, one or more communications interfaces 510, and a communications bus 512.

Non-volatile memory 506 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 508 may include a graphical user interface (GUI) 514 (e.g., a touchscreen, a display, etc.) and one or more input/output (I/O) devices 516 (e.g., a mouse, a keyboard, a microphone, one or more speakers, one or more cameras, one or more biometric scanners, one or more environmental sensors, and one or more accelerometers, etc.).

Non-volatile memory 506 stores an operating system 518, one or more applications 520, and data 522 such that, for example, computer instructions of operating system 518 and/or applications 520 are executed by processor(s) 502 out of volatile memory 504. In one example, computer instructions of operating system 518 and/or applications 520 are executed by processor(s) 502 out of volatile memory 504 to perform all or part of the processes described herein (e.g., processes illustrated and described in reference to FIGS. 1 through 4). In some embodiments, volatile memory 504 may include one or more types of RAM and/or a cache memory that may offer a faster response time than a main memory. Data may be entered using an input device of GUI 514 or received from I/O device(s) 516. Various elements of computing device 500 may communicate via communications bus 512.

The illustrated computing device 500 is shown merely as an illustrative client device or server and may be implemented by any computing or processing environment with any type of machine or set of machines that may have suitable hardware and/or software capable of operating as described herein.

Processor(s) 502 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 502 may be analog, digital or mixed signal. In some embodiments, processor 502 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 510 may include one or more interfaces to enable computing device 500 to access a computer network such as a Local Area Network (LAN), a Wide Area Network (WAN), a Personal Area Network (PAN), or the Internet through a variety of wired and/or wireless connections, including cellular connections.

In described embodiments, computing device 500 may execute an application on behalf of a user of a client device. For example, computing device 500 may execute one or more virtual machines managed by a hypervisor. Each virtual machine may provide an execution session within which applications execute on behalf of a user or a client device, such as a hosted desktop session. Computing device 500 may also execute a terminal services session to provide a hosted desktop environment. Computing device 500 may provide access to a remote computing environment including one or more applications, one or more desktop applications, and one or more desktop sessions in which one or more applications may execute.

In the foregoing detailed description, various features of embodiments are grouped together for the purpose of streamlining the disclosure. This method of disclosure is not to be interpreted as reflecting an intention that the claims require more features than are expressly recited. Rather, inventive aspects may lie in less than all features of each disclosed embodiment.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

Elements of different embodiments described herein may be combined to form other embodiments not specifically set forth above. Other embodiments not specifically described herein are also within the scope of the following claims.

Reference herein to “one embodiment” or “an embodiment” means that a particular feature, structure, or characteristic described in connection with the embodiment can be included in at least one embodiment of the claimed subject matter. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words “exemplary” and “illustrative” is intended to present concepts in a concrete fashion.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although illustrative embodiments of the present disclosure have been described in detail, various changes, substitutions, and alterations could be made hereto without departing from the scope of the present disclosure. Accordingly, it is intended that the scope of the present disclosure be limited not by this detailed description, but rather by the claims appended hereto.

What is claimed is:

1. A computer implemented comprising:
receiving, by an eco fees classification service, information regarding a product to classify;
generating, by the eco fees classification service, a feature vector for the product, the feature vector representing a plurality of relevant features determined from the information regarding the product to classify;
predicting, by the eco fees classification service using an eco fees classification engine, a commodity classification for the product based on the feature vector; and
recommending, by the eco fees classification service, the commodity classification for the product for use in determining an eco fee to apply to a sale of the product.

2. The method of claim 1, further comprising computing the eco fee to apply to the sale of the product based on the recommended commodity classification.

3. The method of claim 1, wherein the eco fees classification engine includes a machine learning (ML) classification model, and wherein the predicting is performed by the ML classification model.

4. The method of claim 3, wherein the ML classification model is a dense neural network (DNN).

5. The method of claim 3, wherein the ML classification model is trained using a training dataset generated from a corpus of product data including historical eco fees compliance reports, product attribute data, product catalog data, and legislative reference data.

6. The method of claim 5, wherein the historical eco fees compliance reports are indicative of adherence to one or more eco fee legislation by an organization.

7. The method of claim 1, wherein the plurality of relevant features includes a variable indicative of an attribute of the product.

8. The method of claim 1, wherein the plurality of relevant features includes a variable indicative of a selling context of the product.

9. A system comprising:
one or more non-transitory machine-readable mediums configured to store instructions; and
one or more processors configured to execute the instructions stored on the one or more non-transitory machine-readable mediums, wherein execution of the instructions causes the one or more processors to carry out a process comprising:
receiving information regarding a product to classify;
generating a feature vector for the product, the feature vector representing a plurality of relevant features determined from the information regarding the product to classify;
predicting, using an eco fees classification engine, a commodity classification for the product based on the feature vector; and
recommending the commodity classification for the product for use in determining an eco fee to apply to a sale of the product.

10. The system of claim 9, wherein the process further comprises computing the eco fee to apply to the sale of the product based on the recommended commodity classification.

11. The system of claim 9, wherein the eco fees classification engine includes a machine learning (ML) classification model, and wherein the predicting is performed by the ML classification model.

12. The system of claim 11, wherein the ML classification model is a dense neural network (DNN).

13. The system of claim 11, wherein the ML classification model is trained using a training dataset generated from a corpus of product data including historical eco fees compliance reports, product attribute data, product catalog data, and legislative reference data.

14. The system of claim 13, wherein the historical eco fees compliance reports are indicative of adherence to one or more eco fee legislation by an organization.

15. The system of claim 9, wherein the plurality of relevant features includes a variable indicative of an attribute of the product.

16. The system of claim 9, wherein the plurality of relevant features includes a variable indicative of a selling context of the product.

17. A computer implemented method to generate a machine learning (ML) model to predict a commodity classification for a product, the method comprising:
determining, from a corpus of product data including historical eco fees compliance reports, product attribute data, product catalog data, and legislative reference data, a plurality of relevant features correlated with commodity classifications;
generating a modeling dataset using the identified plurality of relevant features, the modeling dataset including a plurality of training samples; and
training the ML model using a portion of the plurality of training samples.

18. The method of claim 17, wherein the ML model is a classification model.

19. The method of claim 18, wherein the classification model is a dense neural network (DNN).

20. The method of claim 17, wherein the historical eco fees compliance reports are indicative of adherence to one or more eco fee legislation by an organization.
